(19) United States
(12) Patent Application Publication
(10) Pub. No.: US 2025/0384396 A1
(43) Pub. Date: Dec. 18, 2025

(54) Method And System Of Retrofitted Robotic Components To Pair With Intelligent Sensors To Enumerate And Detect Objects

(71) Applicant: TaskUnite Inc., Buffalo, NY (US)

(72) Inventor: Bianca Gonzalez, Buffalo, NY (US)

(21) Appl. No.: 19/240,609

(22) Filed: Jun. 17, 2025

Related U.S. Application Data
(60) Provisional application No. 63/660,859, filed on Jun. 17, 2024.

(51) Int. Cl. G06Q 10/0875; G06V 10/764

(52) U.S. Cl. CPC G06Q 10/0875; G06V 10/764; G06V 2201/07

(57) ABSTRACT

A method that includes detecting, by a retrofit device that is retrofit to a furniture unit, a triggering condition. Responsive to detecting the triggering condition, the method also includes capturing, by an imaging device of the retrofit device, an image of the furniture unit, and performing, by a processor in communication with the retrofit device, image analysis on the image captured by the imaging device. The method further includes determining, based on the image analysis, a status of the furniture unit.

### CROSS-REFERENCE TO RELATED APPLICATION(S)

This application claims priority to and the benefit of U.S. Provisional Patent Application Ser. No. 63/660,859, filed Jun. 17, 2024, the entire disclosure of which is hereby incorporated by reference.

### TECHNICAL FIELD

This disclosure relates to inventory management, and more particularly, to robotic components paired with systems to enumerate and detect objects in inventory.

### BACKGROUND

Inventory management and enumeration is a laborious activity and consists of inefficient processes, such as manual hand-counting, which can take thousands of labor hours per year in an organization. For example, large enterprises across multiple industries may incur significant annual costs due to leakage and/or spoilage of supplies and inventory. To automate at least a portion of inventory management and enumeration, robotic vision systems may be implemented. However, current robotic vision systems may be large in size, heavy, expensive, costly to transport, or a combination thereof. Additionally, current robotic vision systems may not be customizable or may be unable to move freely to accommodate various inventory management systems. Moreover, the added expense of removing existing inventory-management equipment and installing the robotic vision systems may be cost- and/or time-prohibitive.

### SUMMARY

In one aspect of the present disclosure, a method is disclosed. The method includes detecting, by a retrofit device that is retrofit to a furniture unit, a triggering condition. Responsive to detecting the triggering condition, the method also includes capturing, by an imaging device of the retrofit device, an image of the furniture unit, and performing, by a processor in communication with the retrofit device, image analysis on the image captured by the imaging device. The method further includes determining, based on the image analysis, a status of the furniture unit.

In some configurations, performing the image analysis includes detecting an inventory item contained in the furniture unit based on one or more features of the inventory item within the image. The one or more features include at least one of color, shape, size, spatial proximity to known reference features, a barcode, or a label/

In some configurations, the method includes detecting the label of the inventory item within the image and classifying the inventory item based on the label.

In some configurations, the method includes determining a field of view of an image sensor of the imaging device, comparing the field of view to a predefined threshold condition, and responsive to determining that the field of view corresponds to the predefined threshold condition, articulating the imaging device via the retrofit device to adjust the field of view prior to capturing the image.

In some configurations, articulating the imaging device via the retrofit device includes one or more of translating the imaging device with respect to the furniture unit or rotating the imaging device with respect to the furniture unit.

In some configurations, the method includes determining a field of view of an image sensor of the imaging device based on the image analysis on the image captured by the imaging device, comparing the field of view to a predefined threshold condition, responsive to determining that the field of view corresponds to the predefined threshold condition, articulating the imaging device via the retrofit device to adjust the field of view, and capturing, by the imaging device, an additional image of the furniture unit. The image analysis is performed on the additional image to determine the status of the furniture unit.

In some configurations, the method includes generating an alert when the status of the furniture unit corresponds to a predefined threshold condition and transmitting the status of the furniture unit to an inventory management system for one or more of storage, display, or order initiation.

In some configurations, determining the status of the furniture unit includes one or more of estimating a number of inventory items contained in the furniture unit or estimating a volume of the furniture unit occupied by inventory items.

In some configurations, the triggering condition comprises motion detection or vibration detection that is detected by the retrofit device.

In some configurations, the status of the furniture unit is full, partially full, or empty.

In another aspect of the present disclosure, a system is disclosed. The system includes a retrofit device that is configured for retrofitting to a furniture unit and configured to detect a triggering condition. The retrofit device includes an imaging device, whereby responsive to detecting the triggering condition, the imaging device is configured to capture an image of the furniture unit. The retrofit device also includes a robotic component that is configured to articulate the imaging device to adjust a field of view of an image sensor of the imaging device. The system further includes a server device in communication with the imaging device that includes a processor. The processor is configured to perform an image analysis on the image captured by the imaging device and determine, based on the image analysis, a status of the furniture unit.

In some configurations, the image analysis includes detecting an inventory item contained in the furniture unit based on one or more features of the inventory item within the image. The one or more features include at least one of color, shape, size, spatial proximity to known reference features, a barcode, or a label.

In some configurations, the image analysis further includes detecting the label of the inventory item within the image and classifying the inventory item based on the label.

In some configurations, the processor is configured to determine a field of view of the image sensor based on the image analysis on the image and compare the field of view to a predefined threshold condition. Responsive to determining that the field of view corresponds to the predefined threshold condition, the robotic component is configured to articulate the imaging device to adjust the field of view.

In some configurations, the processor is configured to generate, based on the status of the furniture unit, an alert, and transmit the alert to a user device.

In some configurations, the robotic component includes an articulating device that is configured to one or more of translate the imaging device with respect to the furniture unit or rotate the imaging device with respect to the furniture unit.

In some configurations, the processor is configured to estimate a volume of the furniture unit occupied by inventory items to determine whether the furniture unit is full, partially full, or empty.

In some configurations, one or more of the imaging device or the robotic component is configured to detect the triggering condition. The triggering condition comprises motion detection or vibration detection.

In another aspect of the present disclosure, a method is disclosed. The method includes retrofitting a furniture unit with a retrofit device, whereby the retrofit device includes an imaging device and a robotic component that is configured to articulate the imaging device. The method also includes detecting, by one or more of the imaging device or the robotic component, a triggering condition, and responsive to detecting the triggering condition, capturing, by the imaging device, an image of the furniture unit. The method further includes performing, by a processor in communication with the retrofit device, image analysis on the image captured by the imaging device, and determining, based on the image analysis, a status of the furniture unit, wherein the status of the furniture unit is full, partially full, or empty.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1A illustrates a first example of a furniture unit that contains inventory items therein.

FIG. 1B illustrates the furniture unit of FIG. 1A retrofit with retrofit devices.

FIG. 2 illustrates a second example of a furniture unit retrofit with a second example of retrofit devices.

FIG. 3 illustrates a third example of a furniture unit retrofit with a third example of retrofit devices.

FIG. 4 illustrates a fourth example of a furniture unit retrofit with a fourth example of retrofit devices.

FIG. 5 is a block diagram illustrating an example of an inventory imaging and tracking intelligence system.

FIG. 6 is a block diagram showing an example of a retrofit device coupled to a furniture unit for inventory imaging and tracking inventory items.

FIG. 7 is a block diagram illustrating an example of a workflow of an inventory imaging and tracking intelligence system.

FIG. 8 is a block diagram illustrating an example of a computing device which may be used in an inventory imaging and tracking intelligence system.

FIG. 9 is a flowchart illustrating a first example of a technique for determining a status of a furniture unit using an inventory imaging and tracking intelligence system.

FIG. 10 is a flowchart illustrating a second example of a technique for determining a status of a furniture unit using an inventory imaging and tracking intelligence system.

FIG. 11 is a flowchart illustrating a third example of a technique for determining a status of a furniture unit using an inventory imaging and tracking intelligence system.

### DETAILED DESCRIPTION

The present disclose relates to the use of an inventory imaging and tracking intelligence system to determine (e.g., estimate and/or calculate) a status (e.g., a fill status) of a furniture unit. For example, the inventory imaging and tracking intelligence system may track an inventory count (i.e., quantity) and/or track an inventory volume with respect to a volume of the furniture unit to determine the status of the furniture unit. As used herein, tracking an inventory count and/or an inventory volume refers to the automated process of monitoring and estimating (or in some cases, calculating) a number and/or volume of inventory items within a furniture unit by analyzing images to determine a fill status (e.g., full, partially full, empty) of the furniture unit based on the number and/or volume of inventory items determined to be contained within the furniture unit.

The inventory imaging and tracking intelligence system (hereinafter “system”) may include a retrofit device, which may be retrofit to the furniture unit to enable tracking of the inventory count and/or the inventory volume. For example, the retrofit device may include an imaging device that is configured to capture images of the furniture unit to thereby capture images of the inventory items contained therein. The retrofit device may further include a robotic component, which may articulate (e.g., translate and/or rotate) the imaging device to better capture images of the furniture unit. As such, the retrofit device may enable a cost-effective manner to track the inventory count and/or inventory volume of existing furniture units (e.g., via retrofitting) without needing to replace existing furniture units.

By way of example, a retrofit device may be retrofit (e.g., coupled) to a furniture unit to capture images, via a respective imaging device, of the inventory items contained within the furniture unit. However, based upon placement of the inventory items, a field of view of the retrofit device (i.e., a field of view of an image sensor of an imaging device of the retrofit device) may be obstructed or otherwise impaired by the inventory items. As a result, a robotic component of the retrofit device may articulate the imaging device to move the imaging device, thereby improving the field of view and eliminating the obstruction or other impairment caused by the inventory items. Consequently, the imaging device may capture images of the furniture unit to capture inventory items contained within the furniture unit.

In some configurations, the retrofit device may detect a triggering condition, such as motion or a lapse of time-based interval, and in response to the triggering condition, capture an image of the furniture unit. The image may be transmitted to a server device that performs an image analysis on the image (e.g., based upon instructions executed by a processor of the server device). In some configurations, the image analysis may be performed by the imaging device. For example, the image analysis may be or may include detection and/or classification of inventory items based on identification of one or more features of the inventory items, such as, but not limited to, color, shape, size, spatial proximity to known features of the furniture unit containing the inventory items (e.g., walls, surfaces, or other features that structurally form the furniture unit), a barcode (e.g., a barcode located on the inventory items), and a label (e.g., a label located on the inventory items).

In some configurations, the retrofit device and/or the server device may execute a machine learning model to perform pixel quantification of the captured image to analyze pixel-level distributions with the captured image to estimate a status of the furniture unit. The status of the furniture unit may include an indication of whether the furniture unit is full, partially full (and, optionally, to what extent), or empty. The estimated status may be stored in a database (e.g., a database of the server device) or used to initiate actions, such as alerting a user and/or reordering inventory items. Examples of machine learning models that perform pixel quantification can be found in U.S. patent application Ser. No. 19/200,255, filed on May 6, 2025, the entire contents of which are incorporated herein for all purposes.

The system described herein improves upon traditional inventory tracking technologies by enabling non-intrusive, automated, and real-time estimation of inventory quantities and/or volumes. Unlike systems that may rely solely on physical withdrawal detection or manual counts, the disclosed system may utilize computer vision and machine learning to provide continuous inventory awareness. That is, the disclosed system may be an intelligent vision system, which may utilize trained machine learning models, customized image analysis techniques, and physical retrofitting techniques to implement the disclosed system into existing furniture units. As such, the disclosed system may enable inventory tracking of inventory items contained within conventional furniture units without requiring traditional inventory access methods, such as manual scanning or weighing. By implementing the retrofit device within existing furniture units, the disclosed system may enhance inventory visibility, reduce manual workload, and provide a more intelligent, adaptive inventory control process for any existing inventory storage setting.

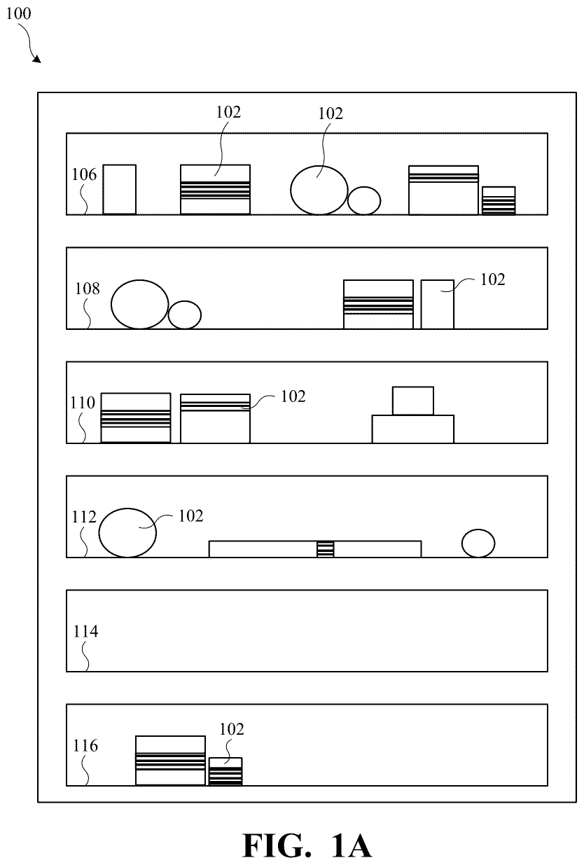

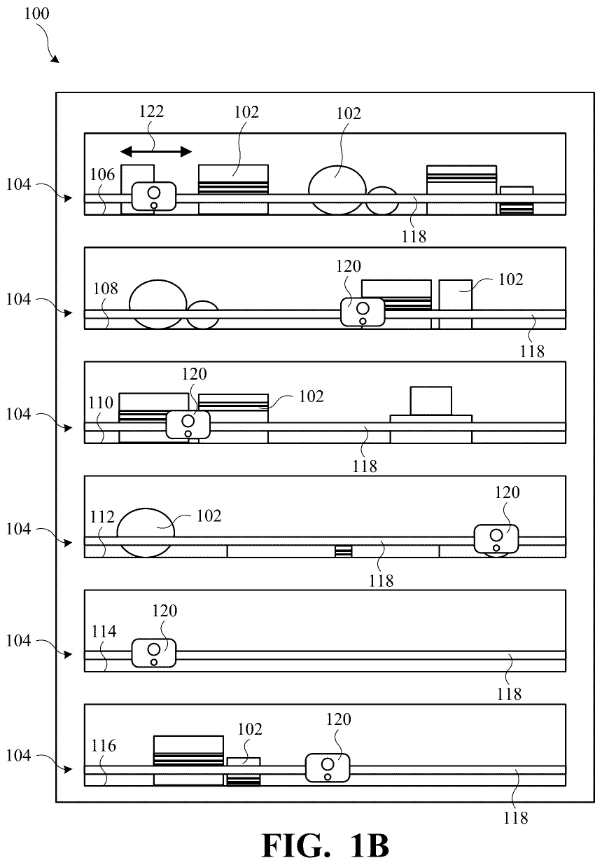

To describe some implementations in greater detail, reference is first made to examples of furniture units retrofit with retrofit devices, which may enable use of the disclosed system. FIG. 1A illustrates a first example of a furniture unit 100 that contains inventory items 102 therein. FIG. 1B illustrates the furniture unit 100 retrofit with retrofit devices 104.

The furniture unit 100 may contain any number of the inventory items 102. As shown in FIGS. 1A and 1B, the inventory items 102 may be any size and/or shape. Moreover, the inventory items 102 may contain a variety of features and/or identifiers, which may be used to identify and/or categorize the inventory items 102. For example, the inventory items 102 contained within the furniture unit 100 may include various types of items, whereby each type of item may be identifiable by at least one of its size, shape, color, label, barcode, or location (e.g., location within the furniture unit 100). As such, the inventory items 102 are not particularly limited to any one item or category of item. By way of example, the inventory items 102 may be, or may include, medical items, hardware items, consumer products, construction materials, sporting goods, food items, beverage items, other items, or a combination thereof.

The furniture unit 100 may be a shelving system or shelving unit that contains one or more shelves, such as a first shelf 106 (i.e., a top shelf), a second shelf 108, a third shelf 110, a fourth shelf 112, a fifth shelf 114, and a sixth shelf 116 (i.e., a bottom shelf). As such, the inventory items 102 may be contained on any one of the shelves of the furniture unit 100. In some configurations, certain types of items may be stored on specific shelves of the furniture unit 100. For example, the inventory items 102 may include a first type of item and a second type of item. The first type of item may be significantly lighter and/or smaller in size than the second type of item. As a result, the first type of item may be stored on the first shelf 106 (i.e., the top shelf), whereas the heavier and/or bulkier second type of item may be stored on the sixth shelf 116 (i.e., the bottom shelf) to minimize the manual workload needed to store and/or retrieve the inventory items 102. In some configurations, the inventory items 102 may be stored within individual containers (e.g., bins, housings, storage units, or the like), whereby the individual containers may be stored within the furniture unit 100 (e.g., on the shelves of the furniture unit 100).

The furniture unit 100 may traditionally be free of any components that may enable automated inventory imaging and tracking (i.e., imaging and tracking of the inventory items 102 contained in the furniture unit 100). That is, the furniture unit 100 may be a conventional shelving system that may only be intended to physically support the inventory items 102. Alternatively, in some configurations, the furniture unit 100 may include one or more automated mechanical systems, such as conveyors or actuators, which may automate storage and/or retrieval of the inventory items 102. However, in either case, inventory tracking may be done manually.

To facilitate automated inventory imaging and tracking of the inventory items 102 contained with the furniture unit 100, the furniture unit 100 may be retrofit with the retrofit devices 104. As shown in FIG. 1B, each of the shelves of the furniture unit 100 may be retrofit with a respective one of the retrofit devices 104. For example, the first shelf 106 may be retrofit with a first one of the retrofit devices 104, the second shelf 108 may be retrofit with a second one of the retrofit devices 104, the third shelf 110 may be retrofit with a third one of the retrofit devices 104, the fourth shelf 112 may be retrofit with a fourth one of the retrofit devices 104, the fifth shelf 114 may be retrofit with a fifth one of the retrofit devices 104, and the sixth shelf may be retrofit with a sixth one of the retrofit devices 104. In some configurations, one or more of the shelves of the furniture unit 100 may be free of the retrofit devices 104. For example, one of the retrofit devices 104 may be configured to facilitate automated inventory imaging and tracking of more than one shelf. Similarly, one or more of the shelves of the furniture unit 100 may be retrofit with more than one of the retrofit devices 104.

Each of the retrofit devices 104 may include a robotic component 118 and an imaging device 120 movably coupled to the robotic component 118. The robotic component 118 may be coupled (i.e., retrofit) to the furniture unit 100 in any desired manner. The robotic component 118 may be coupled to the furniture unit 100 such that the robotic component 118 may be located adjacent to or within a respective one of the shelves of the furniture unit 100. The robotic component 118 may be coupled to the furniture unit 100 such that the robotic component 118 substantially spans a respective one of the shelves of the furniture unit 100. For example, as shown in FIG. 1B, the robotic component 118 of the first one of the retrofit devices 104 may span across a width of the first shelf 106 (e.g., may extend from a first side (i.e., a left side) to an opposing second side (i.e., right side) of the first shelf 106) such that the imaging device 120 of the first one of the retrofit devices 104 may be movable along the width of the first shelf 106. That is, the robotic component 118 of the first one of the retrofit devices 104 may move (e.g., translate or slide) the imaging device 120 of the first one of the retrofit devices 104 along the width of the first shelf 106, such as in the direction 122. A similar configuration may also exist for the remaining retrofit devices for their respective shelves of the furniture unit 100.

The robotic component 118 may be coupled to the furniture unit 100 in any desired manner. For example, the robotic component 118 may be coupled to the furniture unit 100 using one or more fasteners (e.g., nails, screws, bolts, clips, etc.) and/or one or more adhesives. The robotic component 118 may also be connected to a power source, such as a battery of the robotic component 118 and/or an external power source (e.g., a wall outlet in proximity to the furniture unit 100) to power the robotic component 118 to move (e.g., translate) the imaging device 120 that is movably coupled to the robotic component 118. As discussed further herein, the robotic component 118 may move the imaging device to improve a field of view of the imaging device 120 (e.g., a field of view of an image sensor of the imaging device 120) to more effectively capture images of the inventory items 102.

In some implementations, the robotic component 118—and thus the retrofit devices 104—may be freestanding. That is, the robotic component 118 may be free of coupling to the furniture unit 100. In such a case, the robotic component 118 may include or be connected to one or more legs or bases to support the robotic component 118 and facilitate operation thereof. In such a case, the robotic component 118 may be placed adjacent to the furniture unit 100 such that the retrofit devices 104 may be positioned to monitor the inventory items 102 therein.

The robotic component 118 may be, or may contain, an articulating device, which may facilitate movement of the imaging device 120 coupled thereto. For example, the robotic component 118 may be or may include a pan-tilt unit, a servo hinge, a rotary actuator, a linear actuator, a ball screw, a telescoping actuator, an articulating joint (e.g., a robotic arm), another type of motor, another type of actuator, or a combination thereof. Thus, the robotic component 118 may facilitate movement of the imaging device 120 in any desired direction (e.g., in directions other than the direction 122) with respect to the furniture unit 100. For example, the robotic component 118 may facilitate translation (e.g., vertical (i.e., up and down translation with respect to the furniture unit 100 and/or horizontal (i.e., side to side translation of the imaging device 120, rotation (e.g., pan and/or tilt) of the imaging device 120, or both.

The robotic component 118 may be, may contain, or may be in communication with, additional mechanical components, which may facilitate movement of the imaging device 120 based upon implementation of the articulating device of the robotic component 118. For example, the articulating device (e.g., the actuator) of the robotic component 118 may be in communication with a track, guide, or other lateral member that may guide the imaging device 120 in the direction 122 based upon actuation by the actuator. As such, the robotic component 118 may be, or may be part of, a robotic assembly, which may include any number of tracks, guides, arms, members, joints, other components, or a combination thereof.

In some implementations, the imaging device 120 may contain the articulating device (e.g., the actuator) and the robotic component 118 may guide the imaging device 120 in the direction 122 based on movement caused by the articulating device. For example, the robotic component 118 may be a track that guides the articulating device of the imaging device 120 along the track in the direction 122.

The imaging device 120 may be configured to monitor at least a portion of the inventory items 102 stored within or on the furniture unit 100. The imaging device 120 may include an image sensor, a processing component configured to process data captured using the image sensor, a network interface for communicating information processed using the processing component to other devices (e.g., a server), and a power source for supplying power for use by the image sensor, the processing component, and the network interface. In some configurations, the imaging device 120 may be in communication with an external processing component and/or an external network interface to facilitate transmittal and/or processing (e.g., analyzing) of the images captured by the image sensor. In such a case, the imaging device 120 may be free of the processing component and/or the network interface.

As discussed above, the imaging device 120 may be movably coupled to the furniture unit 100 via the robotic component 118. The imaging device 120 may also be removably coupled to the robotic component 118. For example, the imaging device 120 may be coupled to the robotic component 118 using a hook-and-loop fastener, an adhesive strip, another mounting mechanism which enables the removal of the imaging device 120 from the robotic component 118—and thus also removable of the imaging device 120 from the furniture unit 100, or a combination thereof. Alternatively, the imaging device 120 may be fixed (e.g., permanently coupled) to the robotic component 118. For example, the imaging device 120 may be coupled to the robotic component 118 using screws or other mechanical fasteners (e.g., bolts, clips, etc.), an adhesive, a mounting mechanism which may prevent removal of the imaging device 120 from the robotic component 118, or another permanent coupling technique.

The imaging device 120 may be coupled to the robotic component 118 in any desired manner to enable movable positioning of the imaging device 120 to ensure that a field of view of the imaging device 120 (e.g., the field of view of the image sensor of the imaging device 120) accurately captures a desired area or region of the furniture unit 100 and the inventory items 102 therein. For example, as discussed above, each of the shelves of the furniture unit 100 may be retrofit with a respective one of the retrofit devices 104. As such, the imaging device 120 of each of the retrofit devices 104 may be positioned to capture images within their respective shelf (e.g., the imaging device 120 of the first one of the retrofit devices 104 may capture images of the inventory items 102 contained on the first shelf 106, the imaging device 120 of the second one of the retrofit devices 104 may capture images of the inventory items 102 contained on the second shelf 108, etc.).

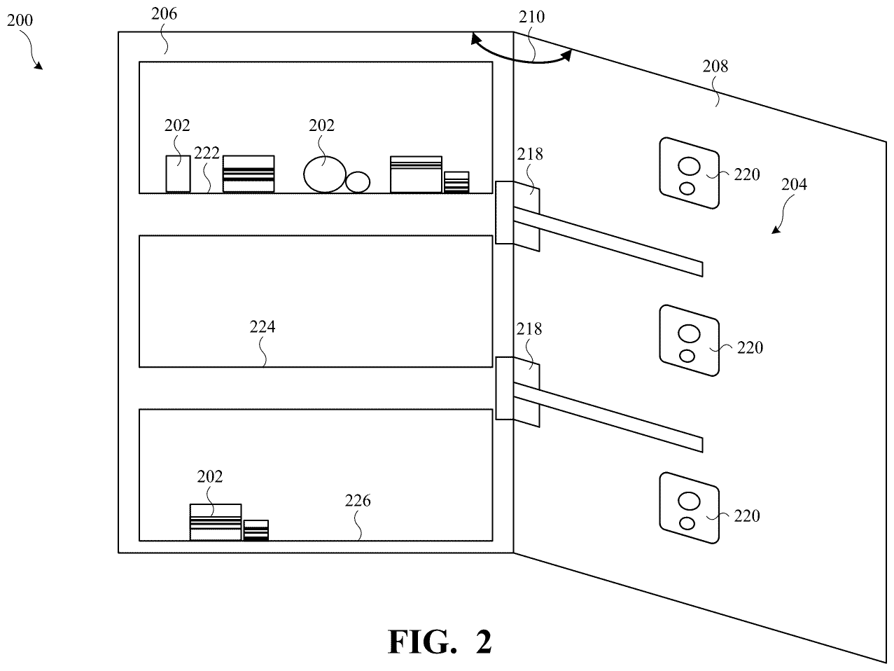

FIG. 2 illustrates a second example of a furniture unit 200 that contains inventory items 202 therein. The furniture unit 200 may be retrofit with a retrofit device 204, which may be used to automate inventory imaging and tracking of the inventory items 202. As such, the furniture unit 200 may be similar to the furniture unit 100 of FIGS. 1A and 1B discussed above. Moreover, the retrofit device 204 may be similar to the retrofit devices 104 of FIG. 1B.

As shown in FIG. 2, the furniture unit 200 may include a cabinet 206 that may be enclosed by a door 208. That is, the door 208 may move in the direction 210 between an open position, in which the door 208 is positioned away from the cabinet 206 to permit access to the inventory items 202 therein, and a closed position, in which the door 208 enclosed the cabinet 206 and the inventory items 202 therein. The door 208 may be configured to lock when in the closed position to protect the inventory items 202 within the cabinet 206. For example, the inventory items 202 may be medical items (e.g., medicine, surgical tools, bandages, etc.), which may be locked within the cabinet 206.

The retrofit device 204 may include one or more robotic components, such as the robotic components 218, and one or more imaging devices, such as the imaging devices 220. The robotic components 218 may be configured to articulate the imaging devices 220. For example, the robotic components 218 may be automated hinges (e.g., servo hinges), which may articulate the door 208 between the open position and the closed position in the direction 210, thereby also moving the imaging devices 220, which may be coupled to the door 208, between the open position and the closed position.

The imaging devices 220 may be coupled (e.g., mounted) to an inner or interior surface of the door 208 such that, when the door 208 is located in the closed position, the imaging devices 220 may capture images of the cabinet 206 and the inventory items 202 therein. By way of example, the cabinet 206 may include one or more shelves, such as a first shelf 222 (i.e., a top shelf), a second shelf 224 (i.e., a middle shelf), and a third shelf 226 (i.e., a bottom shelf). When the door 208 is in the closed position, a first one of the imaging devices 220 may be configured to capture images of the inventory items 202 located on the first shelf 222, a second one of the imaging devices 220 may be configured to capture images of the inventory items 202 located on the second shelf 224, and a third one of the imaging devices 220 may be configured to capture images of the inventory items 202 located on the third shelf 226. As such, the imaging devices 220 may work in conjunction with one another to capture images of all of the inventory items 202 contained within the cabinet 206.

Operation of the imaging devices 220 (e.g., capturing images) may be triggered by one or more triggering events, such as a motion or a time-based interval. By way of example, operation of the imaging devices 220 may be initiated when the door 208 is moved to the closed position. Conversely, operation of the imaging devices 220 may be stopped when the door 208 is moved to the open position (i.e., the position shown in FIG. 2) and/or to an intermediate position located between the open position and the closed position. Thus, the imaging devices 220 may be configured to capture images of the inventory items 202 only when fields of view of the imaging devices 220 (e.g., fields of view of the image sensors of the imaging devices 220) are positioned to contain the cabinet 206 and the inventory items 202 therein. However, the imaging devices 220 may be configured to capture images based upon any triggering events or may be configured to continuously capture images regardless of the position of the door 208.

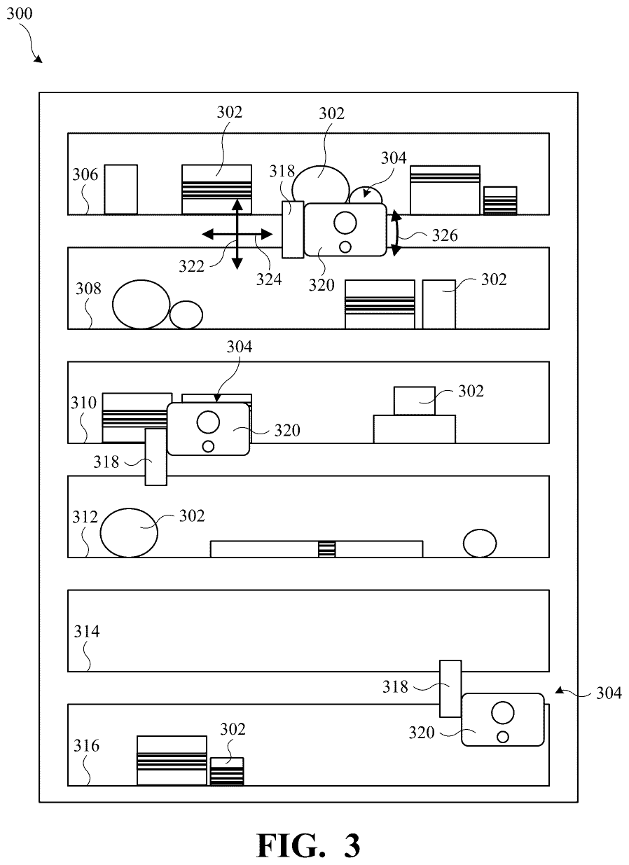

FIG. 3 illustrates a third example of a furniture unit 300 that contains inventory items 302 therein. The furniture unit 300 may be retrofit with one or more retrofit devices, such as the retrofit devices 304, which may be used to automate inventory imaging and tracking of the inventory items 302. As such, the furniture unit 300 may be similar to the furniture unit 100 of FIGS. 1A and 1B or the furniture unit 200 of FIG. 2.

As shown in FIG. 3, the furniture unit 300 may have a similar structure to the furniture unit 100 of FIGS. 1A and 1B. For example, the furniture unit 300 may include a first shelf 306 (i.e., a top shelf), a second shelf 308, a third shelf 310, a fourth shelf 312, a fifth shelf 314, and a sixth shelf 316 (i.e., a bottom shelf). The inventory items 302 may be located on one or more of the shelves of the furniture unit 300. In some cases, one or more of the shelves may be free of any of the inventory items 302 (e.g., when a particular item is depleted due to use or purchasing).

The retrofit devices 304 may each include a robotic component 318 and an imaging device 320 movably coupled to the robotic component 318. For example, the robotic component 318 may be a gimbal-style component that may facilitate translation and/or rotation of the imaging device 320 coupled to the robotic component 318. That is, the robotic component 318 may facilitate translation of the imaging device 320 in one or more directions and/or rotation (e.g., pan and/or tilt) of the imaging device 320 in one or more degrees of rotation.

To further illustrate, a first one of the retrofit devices 304 may be coupled to the furniture unit 300 between the first shelf 306 and the second shelf 308. The robotic component 318 (i.e., the gimbal-style component) of the first one of the retrofit devices 304 may be configured to move the imaging device 320 coupled to the robotic component 318 in a vertical translation direction 322 (i.e., an up-and-down direction) and a horizontal translation direction 324 (i.e., a side-to-side direction). The robotic component 318 of the first one of the retrofit devices 304 may also be configured to rotate the imaging device 320 about one or more degrees of freedom, such as in the rotation direction 326. A similar configuration may exist for a second one of the retrofit devices 304, which may be coupled to the furniture unit 300 between third shelf 310 and the fourth shelf 312, and the third one of the retrofit devices 304, which may be coupled to the furniture unit 300 between the fifth shelf 314 and the sixth shelf 316.

Due to the gimbal-style articulation of the imaging device 320 for each of the retrofit devices 304, each one of the retrofit devices 304 may be able to capture images of the inventory items 302 located on more than one shelf. For example, the first one of the retrofit devices 304 may be configured to articulate the imaging device 320 of the first one of the retrofit devices 304 to capture images of the inventory items 302 located on the first shelf 306 and the second shelf 308. Similarly, the second one of the retrofit devices 304 may be configured to articulate the imaging device 320 of the second one of the retrofit devices 304 to capture images of the inventory items 302 located on the third shelf 310 and the fourth shelf 312. Moreover, the third one of the retrofit devices 304 may be configured to articulate the imaging device 320 of the third one of the retrofit devices 304 to capture images of the inventory items 302 located on the fifth shelf 314 and the sixth shelf 316. Thus, a number of the retrofit devices 304 retrofitted to the furniture unit 300 may be less than the number of shelves, thereby decreasing the cost of retrofitting the furniture unit 300 and the overall footprint of the retrofit devices 304.

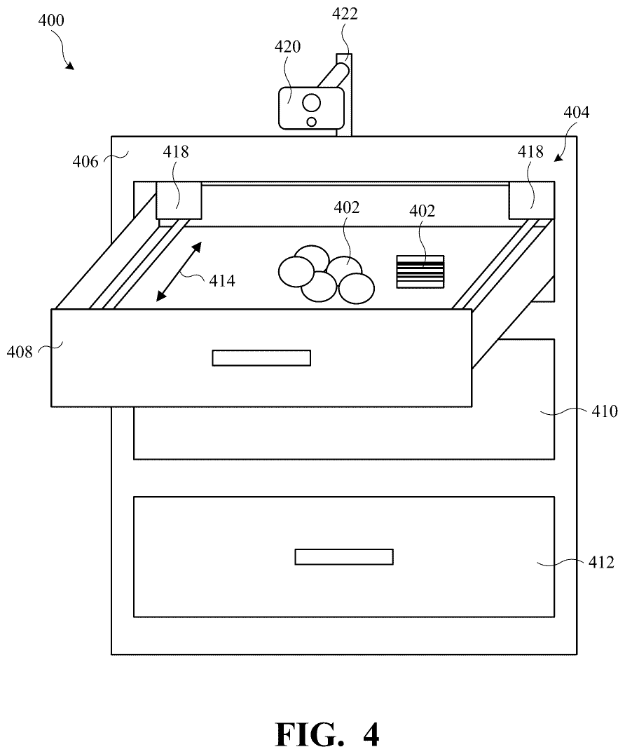

FIG. 4 illustrates a fourth example of a furniture unit 400 that contains inventory items 402 therein. The furniture unit 400 may be retrofit with a retrofit device 404, which may be used to automate inventory imaging and tracking of the inventory items 402. As such, the furniture unit 400 may be similar to the furniture unit 100 of FIGS. 1A and 1B, the furniture unit 200 of FIG. 2, or the furniture unit 300 of FIG. 3.

As shown in FIG. 4, the furniture unit 400 may be a cabinet 406 that includes one or more drawers. For example, the cabinet 406 may include a first drawer 408 (i.e., a top drawer), a second drawer 410 (i.e., a middle drawer), and a third drawer 412 (i.e., a bottom drawer). Each drawer may be configured to move in a direction 414 between an open position (e.g., the position of the first drawer 408 shown in FIG. 4), in which the drawer is positioned away from the cabinet 406 to permit access to the inventory items 402 therein, and a closed position, in which the drawer is contained within the cabinet 406 and the inventory items 402 are enclosed therein. One or more of the drawers may also be configured to lock when in the closed position to protect the inventory items 402 within the drawers. For example, the inventory items 402 may be medical items (e.g., medicine, surgical tools, bandages, etc.), which may be locked within the cabinet 406.

The retrofit device 404 may include one or more robotic components, such as the robotic components 418 located within the first drawer 408. For example, the robotic components may be linear actuators or similar devices, which may facilitate automated opening and closing of the drawers. As such, all or a portion of the drawers may include a portion of the robotic components 418 to enable automated opening and closing. For example, the first drawer 408, the second drawer 410, and the third drawer 412 may all include linear actuators to enable all drawers to be opened and closed automatically (e.g., based upon a triggering event, such as user input on a user device, close proximity of new inventory items to be stored in the cabinet 406, etc.) or otherwise in an automated or semi-automated manner.

The retrofit device 404 further includes an imaging device 420, which may be coupled (e.g., mounted) to the cabinet 406 such that, when any one of the drawers is opened, the imaging device 420 may capture images of the drawers and the inventory items 402 contained within the drawers. In some cases, the imaging device 420 may capture images of the drawers when they are empty (e.g., contain none of the inventory items 402), which may be used to determine that the drawers are empty. For example, the imaging device 420 may be coupled to an upper region (e.g., a top surface) of the cabinet 406 such that a field of view of the imaging device 420 (e.g., a field of view of an image sensor of the imaging device 420) may contain the first drawer 408, the second drawer 410, and the third drawer 412. Thus, the imaging device 420 may be fixed in a desired position to capture images of all of the drawers of the furniture unit 400.

In some configurations, the imaging device 420 may also be configured to articulate (e.g., translate and/or rotate) and/or zoom to adjust the field of view of the imaging device 420 (e.g., the field of view of the image sensor of the imaging device 420). For example, the imaging device 420 may be coupled to the cabinet 406 via a second robotic component 422, which may be configured to articulate the imaging device 420 with respect to the cabinet 406.

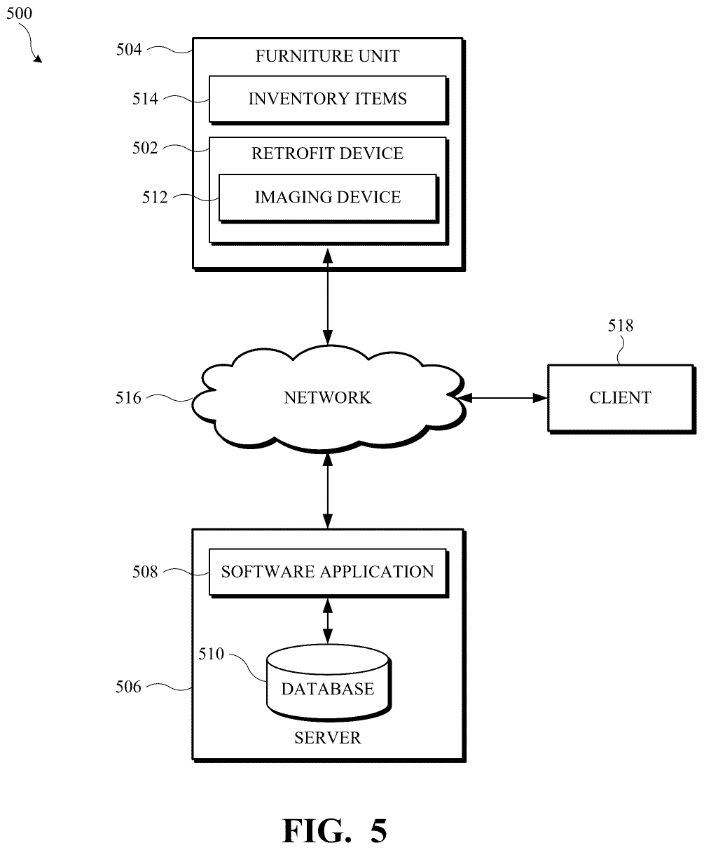

FIG. 5 is a block diagram illustrating an example of a system 500, which may be an inventory imaging and tracking intelligence system. The system 500 may include a retrofit device 502 coupled to a furniture unit 504 and a server 506 that runs a software application 508 and stores a database 510.

The retrofit device 502 may be similar to any of the retrofit devices described above with respect to FIGS. 1A-4. For example, the retrofit device 502 may be configured to articulate one or more portions of the furniture unit 504 (e.g., a drawer, shelf, door, etc.). Alternatively, or additionally, the retrofit device 502 may include an imaging device 512, which may be articulated by the retrofit device 502 (e.g., by a robotic component of the retrofit device 502) to capture images of inventory items 514 contained within or on the furniture unit 504.

The imaging device 512 is configured to monitor the inventory items 514 contained within the furniture unit 504. It should be understood that, aside from the foregoing examples and implementations, the furniture unit 504 may include any type of open or enclosed surfaces or sets of surfaces within or upon which the inventory items 514 may be stored. For example, the furniture unit 504 may be a closet, a freestanding shelving unit, a mobile supply cart, or another structure designed to organize or store the inventory items 514. In some implementations, such as some of those described above, the furniture unit 504 may include one or more enclosures (e.g., a door, lid, sliding panel, curtain, etc.) to protect and/or conceal the inventory items 514.

The imaging device 512 may include an image sensor, a processing component configured to process data captured using the image sensor, and a network interface for communicating information processed using the processing component to other devices (e.g., the server 506.). The imaging device 512 may include or be coupled to a power source configured to supply power to the imaging device 512 and/or other components of the retrofit device 502 (e.g., one or more robotic components). In another example, the imaging device 512 and the other components may receive power from a shared external power source.

The imaging device 512 may capture images of furniture unit 504, which may be used to detect when an inventory item of the inventory items 514 is removed from the furniture unit 504 and/or to identify the inventory item that was removed. In some implementations, the imaging device 512 may use sensors other than the image sensor to detect activity within the furniture unit 504, which may trigger operation of the imaging device 512 (e.g., may trigger image capturing). For example, the imaging device 512 may include a motion sensor, an accelerometer, or another sensor capable of detecting movement, such as vibration, to which the furniture unit 504 is exposed. In another example, the imaging device 512 may include another sensor usable to detect changes within the furniture unit 504 (e.g., movement of inventory items 514 without removal, temperature changes, light changes, etc.) For example, the imaging device 512 may include a weight sensor that may detect when an item is removed and/or moved (e.g., based upon an overall change in weight of furniture unit 504.

The imaging device 512 may be coupled to the furniture unit 504 directly or indirectly. For example, the imaging device 512 may be coupled to the furniture unit 504 directly using one or more of the techniques described above (e.g., via fasteners, adhesives, or the like) or indirectly via the retrofit device 502 or a component thereof (e.g., via a robotic component of the retrofit device 502).

The server 506 may be a computing aspect that runs the software application 508. The server 506 may be or may include a hardware server (e.g., a server device), a software server (e.g., a web server and/or a virtual server), or both. For example, where the server 506 is or includes a hardware server, the server 506 may be a server device located in a rack, such as a rack of a data center.

The software application 508 may be used to process information received from the imaging device 512, for example, over a network 516. In some implementations, the software application 508 may be used to identify an inventory item of the inventory items 514 that has been physically retrieved from the furniture unit 504. In some implementations, the software application 508 may be used to update database records associated with retrieved inventory items from the inventory items 514. In some implementations, the software application 508 may be used to transmit signals indicative of updated database records to a client 518. In some implementations, the software application 508 may be a web application run within a web page served by the server 506 and accessed, for example, by the client 518. In some implementations, the software application 508 may be a mobile application that includes a server-side application running on the server 506 and a client-side application running on the client 518.

The software application 508 may access the database 510 stored on the server 506 to perform at least some of the functionality of the software application 508. The database 510 may be a database or other data store used to store, manage, or otherwise provide data used to deliver functionality of the software application 508. The database 510 may, for example, be a relational database management system, an object database, an XML database, a configuration management database, a management information base, one or more flat files, other suitable non-transient storage mechanisms, or a combination thereof.

The database 510 may store records relating to inventory items (e.g., the inventory items 514) which are or may be monitored using the imaging device 512 or by a different imaging and tracking device within the furniture unit 504 or within a different furniture unit. The database 510 may also store records relating to use instructions, for some or all of the inventory items 514. The database 510 may also store records related to administrative tasks, staff members authorized to retrieve the inventory items 514 from the furniture unit 504, and/or other records.

The software application 508 may present a dashboard that enables a user thereof (e.g., a user of the server 506 or a user of the client 518) to review information processed using the system 500. For example, the dashboard may be used to review information received at the software application 508 from the imaging device 512. In another example, the dashboard may be used to review changes made to records within the database 510 based on the information received from the imaging device 512. In yet another example, the dashboard may be used to view information (e.g., knowledgebase articles or the like) associated with inventory items 514 which have been detected as being physically retrieved from the furniture unit 504.

The imaging device 512 may communicate with the server 506 over the network 516. The network 516 may, for example, be a local area network, a wide area network, a machine-to-machine network, a virtual private network, or another public or private network. Communication over the network 516 may use one or more network protocols, such as using Ethernet, TCP, IP, power line communication, Wi-Fi, Bluetooth®, infrared, GPRS, GSM, CDMA, Z-Wave, ZigBee, another protocol, or a combination thereof.

The client 518 may be given access to the software application 508. The client 518 may be or may include a hardware client (e.g., a client device), a software client (e.g., a web server and/or a virtual server), or both. For example, the client 518 may be a mobile device, such as a smart phone, tablet, laptop, or the like. In another example, the client 518 may be a desktop computer or another non-mobile computer. The client 518 may run a client-side software application or other software to communicate with the software application 508. For example, the client-side software application may be a mobile application that enables access to some or all functionality and/or data of the software application 508. The client 518 communicates with the server 506 over the network 516.

Implementations of the system 500 may differ from what is shown and described with respect to FIG. 5. In some implementations, the imaging device 512 may communicate with the server 506 over the network 516 using an intermediary relay. For example, the intermediary relay may be or include network hardware, such as a router, a switch, a load balancer, another network device, or a combination thereof. The intermediary relay may receive information and/or commands from and/or transmit information and/or commands to the imaging device 512 using one or more network protocols, such as using Ethernet, TCP, IP, power line communication, Wi-Fi, Bluetooth®, infrared, GPRS, GSM, CDMA, Z-Wave, ZigBee, another protocol, or a combination thereof.

In some implementations, the server 506 and the client 518 may each represent computing devices located within a common area. For example, the server 506 and the client 518 may both be computers located within a storage warehouse. In some implementations, the server 506 and the client 518 may be combined into a single computing device. In some implementations, the software application 508 may transmit push notifications, text messages, or other alerts to the client 518 with the client 518 first accessing the software application 508 (e.g., via a webpage or otherwise). For example, the software application 508 may be configured to automatically transmit signals to certain clients, such as using a whitelist or otherwise.

In some implementations, a storage warehouse may use multiple imaging devices. For example, each of the multiple imaging devices may be coupled to a different furniture unit or to different shelves, drawers, or cabinets of the same furniture unit (see, e.g., FIGS. 1B-4). The software application 508 can be used to receive and process signals from each of the multiple imaging devices. For example, the software application 508 may identify individual imaging devices from which data is received, such as within a graphical user interface (GUI) generated by the software application 508 based on the retrieval of an inventory item of the inventory items 514.

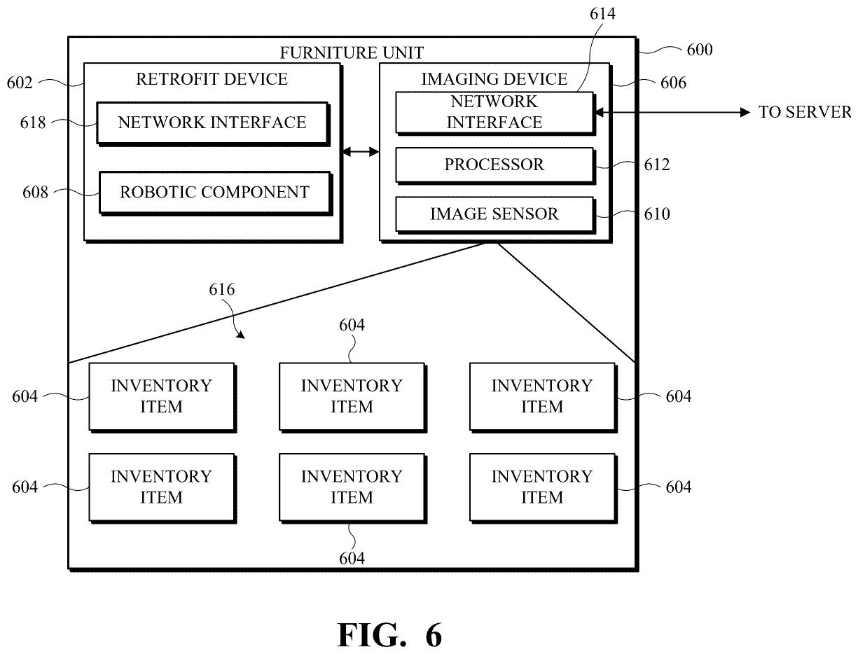

FIG. 6 is a block diagram illustrating an example of a furniture unit 600. A retrofit device 602 may be coupled to the furniture unit 600 for monitoring and tracking inventory items 604. In particular, the retrofit device 602 may include or may be coupled to an imaging device 606, whereby a robotic component 608 of the retrofit device 602 may articulate the imaging device 606. As shown, the imaging device 606 may include an image sensor 610, a processor 612, and a network interface 614. In the implementation shown in FIG. 6, the image sensor 610, the processor 612, and the network interface 614 are internal to the imaging device 606, and the imaging device 606 is coupled to the furniture unit 600. However, in some implementations, the processor 612 and/or the network interface 614 may be external to the furniture unit 600.

The image sensor 610 may be configured to capture images within a field of view 616 of the image sensor 610 or otherwise capture data used to construct images. The image sensor 610 may, for example, be a charge-coupled device sensor, an active pixel sensor, a complementary metal-oxide semiconductor sensor, an N-type metal-oxide-semiconductor sensor, or another sensor or combination of sensors.

The processor 612 may be a central processing unit (CPU), such as a microprocessor, and may include single or multiple processors having single or multiple processing cores. In some implementations, the processor 612 may be or may otherwise refer to an integrated circuit, for example, a field programmable gate array (e.g., FPGA), programmable logic device (PLD), reconfigurable computer fabric (RCF), system on a chip (SoC), an application specific integrated circuit (ASIC), and/or another type of integrated circuit. While not specifically shown in FIG. 6, the processor 612 may include or be coupled to a cache, or cache memory, for local storage of operating data and/or instructions. For example, the cache can be used to temporarily store data recorded using the image sensor 610 and/or another sensor (e.g., in implementations in which the imaging device 606 includes such another sensor).

The network interface 614 may be used to transmit information and/or commands to and/or receive information and/or commands from one or more devices external to the imaging device 606. The network interface 614 may provide a connection or link to a network (e.g., the network 516 of FIG. 5). The network interface 614 may be a wired network interface or a wireless network interface. The imaging device 606 may communicate with other devices via the network interface 614 using one or more network protocols, such as using Ethernet, TCP, IP, power line communication, Wi-Fi, Bluetooth, infrared, GPRS, GSM, CDMA, Z-Wave, ZigBee, another protocol, or a combination thereof. By way of example, in implementations where the imaging device 606 is not integrated into the retrofit device 602 (e.g., the imaging device 606 is coupled to or in communication with the retrofit device 602), the network interface 614 may establish communication with a network interface 618 of the retrofit device 602. For example, in cases where the field of view 616 of the image sensor 610 may be obstructed (for example, by the inventory items 604), the imaging device 606 may communicate with the retrofit device 602 (e.g., via a communication link established between the network interface 614 of the imaging device 606 and the network interface 618 of the retrofit device 602) to activate the robotic component 608 to thereby move the imaging device 606 and thus improve the field of view 616 of the image sensor 610 (e.g., to eliminate the obstruction).

As discussed above, the image sensor 610 may have the field of view 616. The field of view 616 may cover the physical area of the furniture unit 600 for which the image sensor 610 is configured to capture images. The field of view 616 may be adjustable, such as by selectively operating the robotic component 608 and/or by selectively operating the imaging device 606 (e.g., pan, tilt, or zoom). For example, the robotic component 608 may selectively operate based upon commands (e.g., operating instructions) received from a server (e.g., the server 506 of FIG. 5) and/or a client (e.g., the client 518 of FIG. 5), which may be communicated to the robotic component 608—either automatically based upon image analysis conducted by a software application of the server (e.g., based upon a determination that an obstruction of the field of view 616 may exist). In some implementations, the image sensor 610 may be included in a controllable mechanism. For example, a user of a software application that processes information received from the imaging device 606 may use the software application to remotely control, in real-time, a direction of the image sensor 610 via the robotic component 608. Changing the direction of the image sensor 610 may thus cause the specific location of the field of view 616 to change.

The imaging device 606 may operate in a wait state or an active state to optimize resource usage, such as battery power of a battery connected to the imaging device 606 and/or the retrofit device 602. In the wait state, the processor 612 may restrict image capture by the image sensor 610 to preserve resources. The processor 612 may monitor sensor measurements from one or more other sensors, such as an accelerometer detecting vibrations at the furniture unit 600. At a given time, the processor 612 may determine whether the sensor measurements, representative of vibration intensity or frequency, meet a predefined threshold indicative of accessing the furniture unit. If the measurements do not meet the threshold, the processor 612 may determine to maintain the imaging device 606 in the wait state. If the measurements meet the threshold, the processor 612 may change the imaging device 606 to the active state, enabling image capture by the image sensor 610.

By way of example, the one or more sensors may detect vibration of the furniture unit 600 that may be caused by vehicle (e.g., forklift, truck, etc.) operation in close proximity to the furniture unit 600. Similarly, or alternatively, the one or more sensors may detect vibration of the furniture unit 600 that may be caused by construction or other operations in close proximity to the furniture unit 600. In another example, the one or more sensors may detect vibration of the furniture unit 600 caused by a worker inadvertently contacting (e.g., bumping) the furniture unit 600 without accessing the furniture unit 600. In these examples, the vibration intensity of frequency, which is represented by the sensor measurements, may not meet the predefined threshold indicative of accessing the furniture unit, and thus the processor 612 may not change the imaging device 606 to the active state.

In the active state, the image sensor 610 may capture images of the inventory items 604 within the furniture unit 600, such as a first image at a first time. At a second time after the first time, the one or more other sensors produce first sensor measurements representative of vibrations at the furniture unit 600. If the processor 612 determines these measurements do not meet the threshold, the imaging device 606 may remain in the wait state, preserving resources by restricting image capture. At a third time after the second time, the sensors may produce second sensor measurements. If the processor 612 determines these measurements meet the threshold, the imaging device 606 transitions to the active state, and the image sensor 610 captures a second image of the inventory items 604. The processor 612 may process these images to detect visual characteristics, such as color or shape, to identify and enumerate subsets of inventory items by type, enabling precise inventory tracking.

In some implementations, the processor 612 may be configured to initiate image capture by the image sensor 610 based on a predefined schedule, such as at regular time intervals (e.g., every hour or shift). This allows the imaging device 606 to periodically monitor inventory without requiring a motion or vibration trigger, supporting consistent tracking of container fill status.

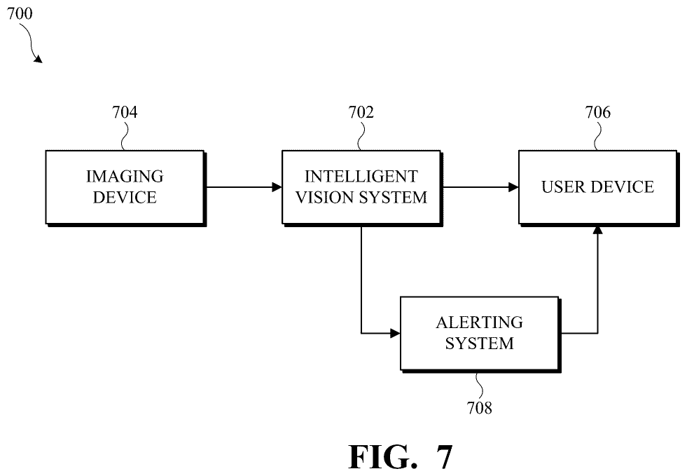

FIG. 7 is a block diagram showing an example of a first workflow 700 of an inventory imaging and tracking intelligence system, hereinafter the system 702. The system 702 may include a processor configured to perform image analysis on image data captured by one or more image devices.

The image analysis may involve using computer vision techniques to detect, classify, count, estimate the volume of, or a combination thereof of inventory items contained within a furniture unit, such as those described herein. The image analysis may identify and/or locate inventory items within an image frame of the captured image. Such identified and/or located inventory items may then be counted (e.g., using bounding boxes around detected items, which may include classification labels). The image analysis may further identify and/or locate various barcodes, Quick Response (QR) codes, labels, or other features of specific inventory items in order to identify and/or locate such items.

By way of example, the system 702 may perform pixel quantification of at least one furniture unit based on image data. The system 702 may be configured to perform pixel quantification using a machine learning model. The machine learning model may be trained on a set of training images labeled with a status of the furniture unit. The system 702 may determine a status of the furniture unit, for example, a fill status of the furniture unit (e.g., full, partially full, or empty). In some implementations, the fill status of the furniture unit may be a percentage, for example, 0% full, 20% full, 50% full, 90% full, 100% full, or the like.

Pixel quantification, as used herein, refers to analyzing a furniture unit image by segmenting and classifying pixels into categories, such as inventory item pixels, furniture unit pixels, or, in some implementations, label pixels (e.g., for labels affixed to the furniture unit and/or the inventory items), and calculating the proportion of inventory item pixels to furniture unit pixels within a defined region, such as a bounding box, to estimate the fill status of the furniture unit.

Pixel quantification may be used to estimate inventory volume in the furniture unit, for example, by calculating a proportion of the number of inventory item pixels relative to the number of furniture unit pixels. For example, an image of an empty furniture unit may include approximately 100% of pixels corresponding to the furniture unit and approximately 0% of pixels corresponding to the inventory item. In another example, an image of a partially full furniture unit may include approximately 80% of pixels corresponding to the furniture unit and approximately 20% of pixels corresponding to the inventory item. In another example, an image of a full furniture unit may include approximately 50% of pixels corresponding to the furniture unit and approximately 50% of pixels corresponding to the inventory item. Pixel quantification may use a proportion (e.g. ratio or percentage) of pixels corresponding to different objects in the image such that images captured at different distances from the furniture unit may be used to accurately estimate inventory volume.

The system 702 may receive images from an imaging device 704 (e.g., the imaging device 512 of FIG. 5 or the imaging device 606 of FIG. 6). The imaging device 704 may be configured to detect a triggering condition. The triggering condition may include motion detection, vibration detection, infrared motion detection, or expiration of a predefined time interval. The imaging device 704 may be configured to ignore the triggering condition based on specific instructions. For example, the imaging device 704 may be configured to ignore the triggering condition due to manual override (e.g., such as a technician is restocking shelves), instructions to ignore triggering conditions within a predefined time period after a triggering condition (e.g., after one trigger (e.g., motion), the system enters a “quiet period” where it ignores further triggers for a set time (e.g., 3 minutes)), or the like. The imaging device 704 may be configured to receive (e.g., from the system 702) an updated triggering condition (e.g., an updated threshold or updated time interval). The imaging device 704 may replace the triggering condition with the updated triggering condition, and may transmit (e.g., to the system 702) confirmation of the updated triggering condition.

The imaging device 704 may be configured to capture an image of at least one furniture unit. Capturing an image of the at least one furniture unit may be performed in response to detecting the triggering condition. The imaging device 704 may include one or more sensors, such as an image sensor (e.g., the image sensor 610), a motion sensor, an infrared sensor, a vibration sensor, or the like. The imaging device 704 may be removably or permanently coupled to a furniture unit. For example, the imaging device 704 may be retrofit to a furniture unit using the techniques described herein. As such, the imaging device 704 may be part of a retrofit device used to enable use of the system 702.

The captured image may be transmitted from the imaging device 704 to the system 702. Transmitting the captured image from the imaging device 704 to the system 702 may include using a network interface of the imaging device 704 to wirelessly communicate the captured image to the system 702.

The system 702 may communicate with a user device 706. The user device 706 may be configured to receive the status of the furniture unit from the system 702. The user device 706 may display the furniture unit status to a user. The displayed status may include whether the furniture unit is full, partially full, or empty. The user device 706 may be a mobile device or a desktop device. The user device 706 may run a client-side application for viewing inventory data.

The system 702 may be communicatively connected to an alerting system 708. The alerting system 708 may be configured to generate an alert based on the status of the furniture unit. The alert may be generated when the status of the furniture unit meets or falls below a predefined threshold condition. For example, the alert may be generated when the status changes from full to partially full, when the status becomes empty, or when the status falls below a specified percentage (e.g., 50%, 20%, 0%, or the like). The alerting system 708 may transmit the alert to the user device 706. The alert may notify a user associated with the user device 706 that the furniture unit requires replenishment or that an inventory condition has been met. The alert may be delivered as a push notification, text message, or interface prompt within the client application.

Alternatively, the alert may trigger a signal to an inventory management system to automatically place an order for the inventory item associated with the furniture unit. The signal may include information such as an item identifier, a quantity to be ordered, a location of the container, and an urgency level. The inventory management system may process the signal to generate a purchase order, initiate fulfillment with a supplier, or schedule internal restocking procedures. The inventory management system may apply predefined ordering rules based on consumption patterns, threshold levels, or supply chain constraints. In some implementations, user approval may be required to confirm the order before execution. Alternatively, the order may be placed automatically without manual intervention. Automatic inventory ordering may reduce manual inventory tracking and help maintain optimal stock levels.

In some implementations, the system 702 may generate an output comprising an image of the furniture unit annotated with fill status labels for remote viewing by an authorized user through an administrative user interface. To illustrate, upon a user request for inventory status via the administrative user interface, the imaging device 704 captures an image or video feed of the furniture unit. The system 702 may process the image using the machine learning model to determine the fill status (e.g., full, partially full, empty) of a type of inventory item based on pixel quantification, as described herein. The system 702 may then annotate each type of inventory item in the image with a visual label indicating its fill status, such as a green label for full, yellow for partially full, or red for empty, typically positioned in a designated region (e.g., top left corner) of the inventory items' bounding box. Examples of outputs containing annotated furniture units can be found in U.S. patent application Ser. No. 19/200,255, filed on May 6, 2025, the entire contents of which are incorporated herein for all purposes.

To further illustrate, the system 702 may process an image of a furniture unit that includes two types of inventory items (e.g., a first type and a second type). The system 702 may then output an annotated image of the furniture unit (e.g., an annotated version of the initial image captured). The annotated image may include a green label that identifies (e.g., by text) the first type of inventory item to indicate that the first type of inventory item is full. The annotated image may also include a yellow label that identifies (e.g., by text) that second type of inventory item to indicate that the second type of inventory item is partially full. In some implementations, the labels may also identify an inventory count for each type of inventory item.

Authorized users, such inventory managers, may access the administrative user interface via a client device (e.g., the client 518) to remotely monitor inventory. The user interface may display the annotated image, enabling users to visually assess the fill status of multiple furniture units simultaneously. The annotated labels facilitate rapid identification of inventory conditions, supporting timely restocking decisions or compliance checks. The system may store the annotated image in the database (e.g., database 510) for record-keeping or transmit it to the user device as part of an alert or status update, enhancing inventory visibility and operational efficiency.

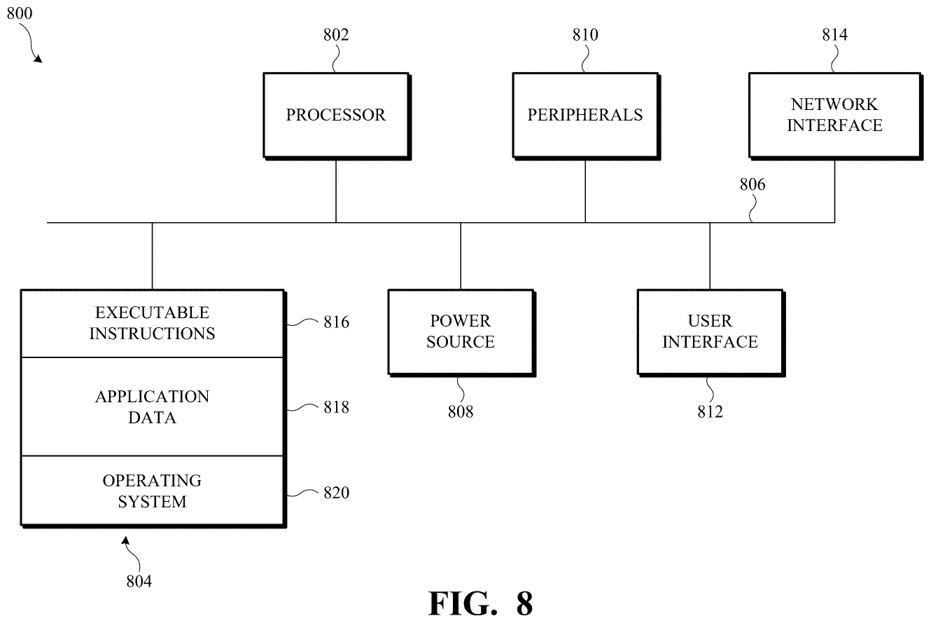

FIG. 8 is a block diagram of an example of a computing device 800 which may be used in an inventory imaging and tracking intelligence system, for example, the system 500 of FIG. 5. The computing device 800 may be used to implement a server on which a software application is run (e.g., the server 506 and the software application 508 shown in FIG. 5). Alternatively, the computing device 800 may be used to implement a client that accesses the software application (e.g., the client 518 shown in FIG. 5). As a further alternative, the computing device 800 may be used as or to implement another client, server, or other device according to the implementations disclosed herein. The computing device 800 includes components or units, such as a processor 802, a memory 804, a bus 806, a power source 808, peripherals 810, a user interface 812, and a network interface 814. One or more of the memory 804, the power source 808, the peripherals 810, the user interface 812, or the network interface 814 may communicate with the processor 802 via the bus 806.

The processor 802 may be a central processing unit (CPU), such as a microprocessor, and can include single or multiple processors having single or multiple processing cores. Alternatively, the processor 802 can include another type of device, or multiple devices, now existing or hereafter developed, configured for manipulating or processing information. For example, the processor 802 can include multiple processors interconnected in any manner, including hardwired or networked, including wirelessly networked. For example, the operations of the processor 802 can be distributed across multiple devices or units that can be coupled directly or across a local area or other suitable type of network. The processor 802 can include a cache, or cache memory, for local storage of operating data and/or instructions.

The memory 804 may include one or more memory components, which may each be volatile memory or non-volatile memory. For example, the volatile memory of the memory 804 can be random access memory (RAM) (e.g., a DRAM module, such as DDR SDRAM) or another form of volatile memory. In another example, the non-volatile memory of the memory 804 can be a disk drive, a solid state drive, flash memory, phase-change memory, or another form of non-volatile (or non-transitory) memory configured for persistent electronic information storage. The memory 804 may also include other types of devices, now existing or hereafter developed, configured for storing data or instructions for processing by the processor 802.

The memory 804 can include data for immediate access by the processor 802. For example, the memory 804 can include executable instructions 816, application data 818, and an operating system 820. The executable instructions 816 can include one or more application programs, which can be loaded or copied, in whole or in part, from non-volatile memory to volatile memory to be executed by the processor 802. For example, the executable instructions 816 can include instructions for performing some or all of the techniques of this disclosure. The application data 818 can include user data, database data (e.g., database catalogs or dictionaries), or the like. The operating system 820 can be, for example, Microsoft Windows®, Mac OS X®, or Linux®; an operating system for a small device, such as a smartphone or tablet device; or an operating system for a large device, such as a mainframe computer.

The power source 808 may include a source for providing power to the computing device 800. For example, the power source 808 can be an interface to an external power distribution system. In another example, the power source 808 can be a battery, such as where the computing device 800 is a mobile device or is otherwise configured to operate independently of an external power distribution system.

The peripherals 810 may include one or more sensors, detectors, or other devices configured for monitoring the computing device 800 or the environment around the computing device 800. For example, the peripherals 810 can include a geolocation component, such as a global positioning system location unit. In another example, the peripherals can include a temperature sensor for measuring temperatures of components of the computing device 800, such as the processor 802.

The user interface 812 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 814 provides a connection or link to a network (e.g., the network 516 shown in FIG. 5). The network interface 814 can be a wired network interface or a wireless network interface. The computing device 800 can communicate with other devices via the network interface 814 using one or more network protocols, such as using Ethernet, TCP, IP, power line communication, Wi-Fi, Bluetooth, infrared, GPRS, GSM, CDMA, Z-Wave, ZigBee, another protocol, or a combination thereof.

Implementations of the computing device 800 may differ from what is shown and described with respect to FIG. 8. In some implementations, the computing device 800 can omit the peripherals 810. In some implementations, the memory 804 can be distributed across multiple devices. For example, the memory 804 can include network-based memory or memory in multiple clients or servers performing the operations of those multiple devices. In some implementations, the application data 818 can include functional programs, such as a web browser, a web server, a database server, another program, or a combination thereof.

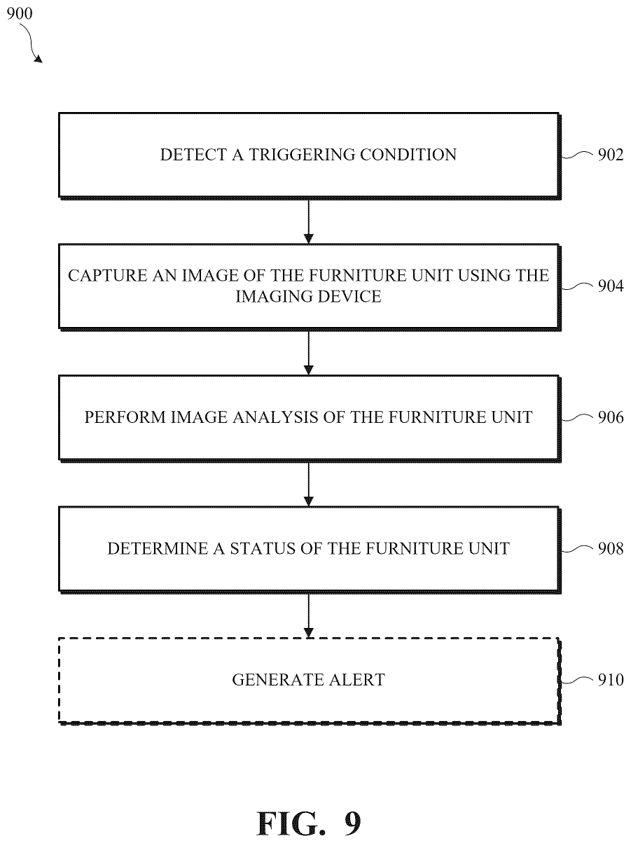

FIG. 9 is a flowchart showing an example of a first technique 900 for determining inventory using an inventory imaging and tracking intelligence system. The first technique 900 can be executed using computing devices, such as the systems, hardware, and software described with respect to FIGS. 5-8. The first technique 900 can be performed, for example, by executing a machine-readable program or other computer-executable instructions, such as routines, instructions, programs, or other code. The steps, or operations, of the first technique 900 or another technique, method, process, or algorithm described in connection with the implementations disclosed herein can be implemented directly in hardware, firmware, software executed by hardware, circuitry, or a combination thereof.

At 902, a furniture unit is retrofit with a retrofit device.

At 902, a triggering condition may be detected by a retrofit device and/or an imaging device thereof that is retrofit to a furniture unit, whereby the imaging device may be positioned to capture one or more images of the furniture unit and the inventory items therein. The furniture unit can be any one of the furniture units described herein or another furniture unit. The retrofit device may be any retrofit device, such as the retrofit devices shown and described in FIGS. 1A-6, which may include or be coupled to an imaging device, whereby the imaging device may include an image sensor (e.g., the image sensor 610 shown in FIG. 6), which may capture images of the furniture unit and inventory items contained therein. As described herein, the retrofit device may be coupled (e.g., mounted) to the furniture unit in any desired manner to removably or permanently couple the retrofit device, including the imaging device, to the furniture unit. Moreover, the retrofit device may facilitate articulation of the imaging device with respect to the furniture unit to adjust a field of view of the image sensor prior to capturing an image

As discussed herein, the imaging device may be positioned capture an image of the furniture unit to detect and/or identify the inventory items therein. The triggering condition may include motion detection, such as a motion the corresponds to a person reaching into or interacts with the furniture unit (e.g., cabinet, drawer, shelf, or the like). In some cases, the first technique 900 may use a vibration sensor to detect physical activity involving the furniture unit, such as the opening of a drawer or a potential interaction with inventory items. While vibration alone may not confirm the specific nature of the event, it can serve as a triggering condition to activate further monitoring, such as image capture. The triggering condition may include a sensor measurement, such as vibration intensity or frequency, exceeding a predefined threshold, causing the imaging device to transition from a wait state, where image capture is restricted to preserve resources, to an active state, enabling capture of one or more images of inventory items contained within the furniture unit. The triggering condition may include expiration of a predefined time interval, such as every 30 minutes, every three hours, every shift, or on a fixed schedule. Detecting the triggering condition may activate the imaging device positioned to capture images of the furniture unit in which the inventory items are stored.

At 904, the imaging device may capture an image of the furniture unit. The image may be captured in response to the triggering condition. The image may be a still image or a frame from a video feed. The furniture unit may be a bin, shelf compartment, drawer segment, or similar structure. The furniture unit may include one or more inventory items. The image may also include visual indicators, such as printed product labels, QR codes, or barcodes affixed to one or more of the inventory items and/or the furniture unit. The visual indicators may be used to classify or associate the inventory items with a specific type of inventory item. Similarly, the visual indicators may be used to classify or associate the furniture unit with a specific type of inventory item (e.g., based upon a product label disposed on the furniture unit).

At 906, the first technique 900 performs image analysis. As discussed herein, the image analysis may be any type of computer vision-based analysis that may identify, classify (e.g., sort, group, etc.), count, estimate a volume of, or a combination thereof the inventory items. By way of example, the system may perform pixel quantification of the furniture unit using a trained machine learning model. The model may be trained using a labeled training dataset that includes images of the furniture unit in known fill states, such as fully stocked, half full, and empty. During inference, the system may segment pixels of the image of the furniture unit to identify pixels that correspond to inventory items (e.g., inventory item pixels) and pixels that correspond to the furniture unit (e.g., furniture unit pixels). The system may determine a number of inventory item pixels and a number of furniture unit pixels. Some pixels may also be classified as label pixels, for example, when the system identifies product names, text, or standardized visual markers. Pixel classification may be based on color gradients (e.g., distinguishing red products from a beige bin that contains the red products), object shapes (e.g., the cylindrical profile of haircare products), size (e.g., a size of the inventory item compared to a size of the furniture unit, a size of a container within the furniture unit that contains the inventory item, or a size of another inventory item), and spatial proximity to known features of the furniture unit (e.g., furniture unit walls or a label on the furniture unit).

At 908, the system determines a status of the furniture unit based on the image analysis. The status of the container may be, for example, a fill status. The fill status may be expressed as a category (e.g., full, partially full, or empty) or as a percentage estimate of volume occupied by inventory items. For example, in the example where pixel quantification may be implemented for image analysis, if 35% of the furniture unit pixels are classified as inventory item pixels, the system may determine that the fill status is 50% full. The system may also assign a confidence score to this estimate, such as a 90% confidence that the furniture unit is between 40-60% full. The status of the furniture unit may be determined by calculating a proportion of the number of inventory item pixels relative to the number of furniture unit pixels. In some implementations, the system may extract label pixels and use optical character recognition (OCR) to associate the label with a specific inventory item.

At 910, the first technique 900 may further generate an alert when the determined fill status falls below a predefined threshold, such as when a furniture unit is less than 50% full. This alert may be transmitted to a user device as a push notification, text message, or interface banner. In some cases, the alert may also include the item name and location of the furniture unit. Additionally, the system may transmit the fill status to an inventory management system for storage, display, or order initiation. For example, the system may automatically generate a restock request for the furniture unit when an alert is triggered. In another example, the system may automatically place a purchase order for the inventory item associated with the furniture unit.

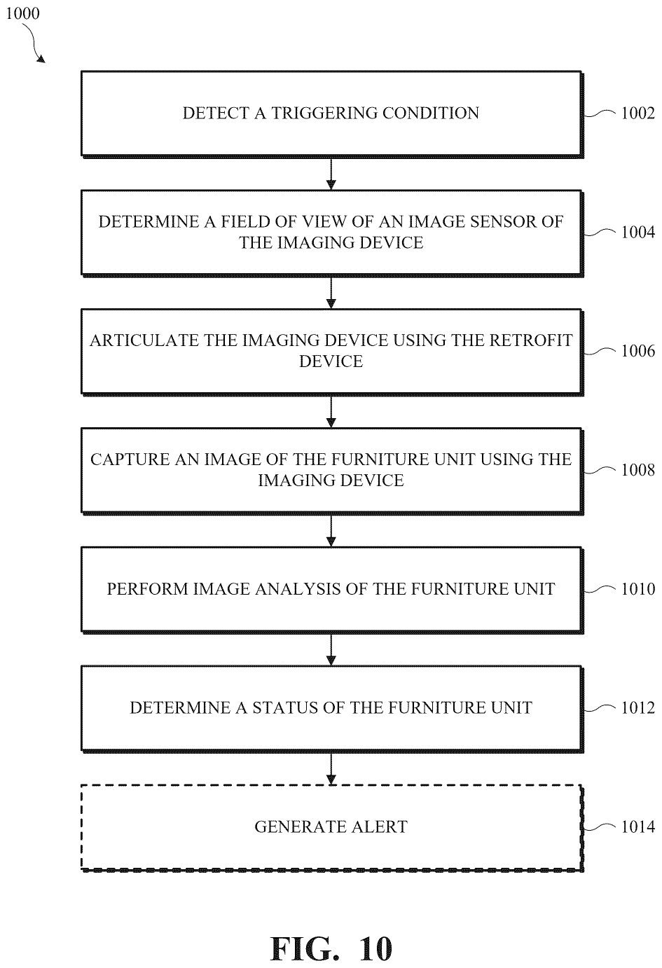

FIG. 10 is a flowchart showing an example of a second technique 1000 for determining inventory using an inventory imaging and tracking intelligence system. The second technique 1000 can be executed using computing devices, such as the systems, hardware, and software described with respect to FIGS. 1A-8. The second technique 1000 can be performed, for example, by executing a machine-readable program or other computer-executable instructions, such as routines, instructions, programs, or other code. The steps, or operations, of the second technique 1000 or another technique, method, process, or algorithm described in connection with the implementations disclosed herein can be implemented directly in hardware, firmware, software executed by hardware, circuitry, or a combination thereof.

At 1002, a triggering condition may be detected by a retrofit device and/or an imaging device thereof that is retrofit to a furniture unit, whereby the imaging device may be positioned to capture one or more images of the furniture unit and the inventory items therein. The furniture unit can be any one of the furniture units described herein or another furniture unit. The retrofit device may be any retrofit device, such as the retrofit devices shown and described in FIGS. 1A-6, which may include or be coupled to an imaging device, whereby the imaging device may include an image sensor (e.g., the image sensor 610 shown in FIG. 6), which may capture images of the furniture unit and inventory items contained therein. As described herein, the retrofit device may be coupled (e.g., mounted) to the furniture unit in any desired manner to removably or permanently couple the retrofit device, including the imaging device, to the furniture unit. Moreover, the retrofit device may facilitate articulation of the imaging device with respect to the furniture unit to adjust a field of view of the image sensor prior to and/or after capturing an image, as discussed herein. The triggering condition may be detected in a similar manner to the triggering condition detected at 902 of the first technique 900 shown in FIG. 9.

At 1004, a field of view of an image sensor of the imaging device may be determined. As described herein, the imaging device may include an image sensor (e.g., the image sensor 610 shown in FIG. 6), which may have a field of view (e.g., the field of view 616 of the image sensor 610 shown in FIG. 6) to capture images of the furniture unit and the inventory items therein. As such, the field of view of the image sensor may be positioned such that the furniture unit or a portion thereof (e.g., when multiple imaging devices may be used) is located within the field of view.

Determining the field of view of the image sensor at 1006 may include determining whether the field of view is obstructed or otherwise blocked such that the images captured by the imaging device may not clearly reflect the furniture unit and/or the inventory items therein. For example, a bulky or oversized inventory item may be positioned within the furniture unit close to the imaging device such that the bulky or oversized inventory item may obstruct the field of view and block the imaging device from capturing the inventory items located behind the bulky or oversized inventory. Similarly, the imaging unit may be inadvertently hit when storing and/or retrieving inventory items from the furniture, thereby moving the position of the imaging device and thus changing the field of view (e.g., changing the field of view such that the furniture unit is no longer properly located within the field of view). As a result, when the image is captured by the imaging device, the system may be unable to accurately identify the inventory items contained within the furniture unit.

As such, the field of view of the image sensor may be determined so identify whether obstruction or blocking within the image is present. For example, the system may be configured to analyze an initial image captured by the imaging device to evaluate identify whether obstruction or blocking is present. That is, the imaging device may capture an initial image (e.g., based upon a triggering condition detected at 1002) and the system may analyze the initial image to detect one or more predefined conditions which may correspond to an obstruction or blocking. In an implementation, the system may implement an image analysis similar to the image analysis utilized to determine a status (e.g., a fill status) of the furniture unit, such as by using pixel quantification or other computer vision-based analyses.

For example, the system may be configured to compared the size of a particular inventory item (e.g., the size of a bounding box associated with an inventory items based upon pixel quantification) against a predefined threshold (e.g., a predefined size threshold) for that particular inventory item. If the size of the particular inventory item exceeds the predefined threshold (e.g., is larger than the predefined size threshold), it may be determined that the particular inventory item is positioned too closely in the foreground of the image captured and thereby obstructing the view of the furniture unit. Alternatively, or additionally, the system may be configured to determine whether the size of a particular inventory item occupies an abnormally large proportion of the image (i.e., an abnormally large portion of the furniture unit). For example, a size of the particular inventory item may be compared to a predefined threshold, which may correspond to proportion threshold (e.g., a percentage). If the particular inventory item exceeds the proportion threshold (e.g., the particular inventory items accounts for greater than 60% of the image frame, greater than 70% of the image frame, etc.), the system may determine that the inventory item is obstructing the view of the furniture unit.

Other techniques may also be implemented to determine the field of view and identify obstructions or blockages therein. For example, occlusion analysis may be implemented by analyzing regions of the captured image where a closer inventory item occludes areas beyond it based upon depth discontinuities. Additionally, or alternatively, the system may be configured to monitor edge and/or texture density of the inventory items to identify whether inventory items have a low edge density within a large region of the captured image, which may indicate a possible obstruction. Moreover, the system may be configured to perform blind spot detection, which may be used to determine whether a portion of the furniture unit that is expected to be visible (e.g., a leg, support, hinge, etc.) is in fact visible. If the portion of the furniture unit that is expected to be visible is missing or covered, an obstruction may exist.

If at 1004 the field of view of the image sensor is determined to not be obstructed or otherwise blocked, the system may capture an image at 1008 and/or utilize an initial image captured at 1004 that is used to determine the field of view of the image sensor. However, if at 1004 the field of view of the image sensor is determined to be obstructed or otherwise blocked, the imaging device may be articulated at 1006 using the retrofit device. For example, one or more robotic components of the retrofit device, such as those described herein, may translate (e.g., slide) and/or rotate (e.g., pan and/or tilt) the imaging device to move the image sensor and thus adjust the field of view of the image sensor. In some implementations, a user may manually operate the one or more robotic components of the retrofit device via a user interface (e.g., the client 518 of FIG. 5) to adjust the field of view. In some implementation, the one or more robotic components of the retrofit device may be automatically moved, such as based upon a command communicated to the one or more robotic components and/or the imaging device from a server (e.g., the server 506 operating the software application 508, as shown in FIG. 5). For example, the server may operate a software application to determine whether the field of view is blocked. If the field of view is blocked, the server may automatically communicate to the one or more robotic components an operating command, which may trigger the one or more robotic components to move the imaging device to one or more predefined locations (e.g., alternative locations). The field of view may then be determined once again at 1004 (e.g., to determine whether the obstruction or blockage still exists) until the obstruction or blockage is no longer present.

At 1008, the imaging device may capture an image of the furniture unit (e.g., a second image of the furniture unit if an initial image is captured at 1004 to determine the field of view of the image sensor). The image may be captured in response to the triggering condition. The image may be a still image or a frame from a video feed. The furniture unit may be a bin, shelf compartment, drawer segment, or similar structure. The furniture unit may include one or more inventory items. The image may also include visual indicators, such as printed product labels, QR codes, or barcodes. The visual indicators may be used to classify or associate the inventory items with a specific type of inventory item. Similarly, the visual indicators may be used to classify or associate the furniture unit with a specific type of inventory item (e.g., based upon a product label disposed on the furniture unit.

At 1010, the second technique 1000 performs image analysis. The image analysis may be similar to the image analysis performed at 906 in the first technique 900 shown in FIG. 9. For example, the image analysis may be any type of computer vision-based analysis that may identify, classify (e.g., sort, group, etc.), count, estimate a volume of, or a combination thereof the inventory items, such as by performing pixel quantification of the furniture unit using a trained machine learning model.

At 1012, the second technique 1000 determines a status of the furniture unit based on the image analysis. The status of the container may be, for example, a fill status. The fill status may be expressed as a category (e.g., full, partially full, or empty) or as a percentage estimate of volume occupied by inventory items. The status of the furniture unit may be determined in a similar manner to the determination at 908 of the first technique 900 shown in FIG. 9.

At 1014, the second technique 1000 may further generate an alert when the determined fill status falls below a predefined threshold, such as when a furniture unit is less than 50% full. This alert may be transmitted to a user device as a push notification, text message, or interface banner. In some cases, the alert may also include the item name and location of the furniture unit. Additionally, the system may transmit the fill status to an inventory management system for storage, display, or order initiation. For example, the system may automatically generate a restock request for the furniture unit when an alert is triggered. In another example, the system may automatically place a purchase order for the inventory item associated with the furniture unit.

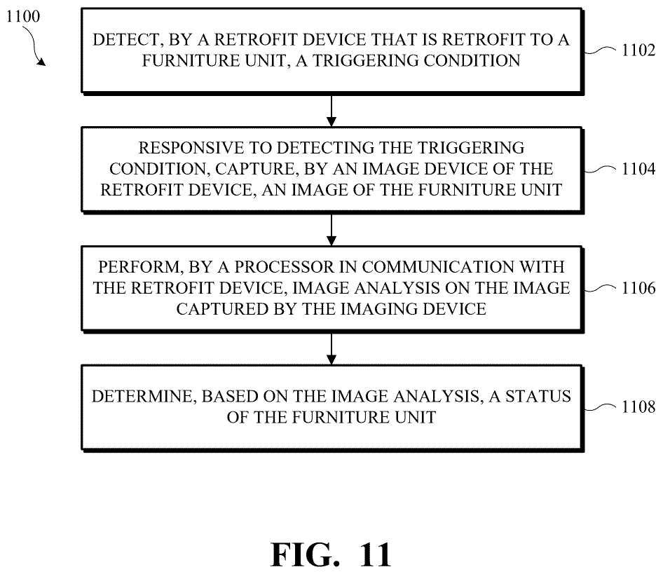

FIG. 11 is a flowchart showing an example of a third technique 1100 for determining inventory using an inventory imaging and tracking intelligence system. The third technique 1100 can be executed using computing devices, such as the systems, hardware, and software described with respect to FIGS. 1A-8. The third technique 1100 can be performed, for example, by executing a machine-readable program or other computer-executable instructions, such as routines, instructions, programs, or other code. The steps, or operations, of the third technique 1100 or another technique, method, process, or algorithm described in connection with the implementations disclosed herein can be implemented directly in hardware, firmware, software executed by hardware, circuitry, or a combination thereof.

At 1102, the third technique 1100 may detect, by a retrofit device that is retrofit to a furniture unit, a triggering condition. The furniture unit can be any one of the furniture units described herein or another furniture unit. The retrofit device may be any retrofit device, such as the retrofit devices shown and described in FIGS. 1A-6, which may include or be coupled to an imaging device, whereby the imaging device may include an image sensor (e.g., the image sensor 610 shown in FIG. 6), which may capture images of the furniture unit and inventory items contained therein. As described herein, the retrofit device may be coupled (e.g., mounted) to the furniture unit in any desired manner to removably or permanently couple the retrofit device, including the imaging device, to the furniture unit. Moreover, the retrofit device may facilitate articulation of the imaging device with respect to the furniture unit to adjust a field of view of the image sensor prior to and/or after capturing an image, as discussed herein. The triggering condition may be detected in a similar manner to the triggering condition detected at 902 of the first technique 900 of FIG. 9 or the triggering condition detected at 1002 of the second technique 1000 of FIG. 10. The triggering condition may be any one or more of the triggering conditions described herein.

At 1104, responsive to detecting the triggering condition at 1102, imaging device of the retrofit device may capture an image of the furniture unit. The image may be a still image or a frame from a video feed. The furniture unit may be a bin, shelf compartment, drawer segment, or similar structure. The furniture unit may include one or more inventory items. The image may also include visual indicators, such as printed product labels, QR codes, or barcodes. The visual indicators may be used to classify or associate the inventory items with a specific type of inventory item. Similarly, the visual indicators may be used to classify or associate the furniture unit with a specific type of inventory item (e.g., based upon a product label disposed on the furniture unit.

At 1106, a processor in communication with the retrofit device may perform image analysis on the image captured by the imaging device. The processor may be any processor described herein, such as a processor of the server 506 shown in FIG. 5 or the processor 612 of the imaging device 606 shown in FIG. 6. The image analysis may be similar to the image analysis performed at 906 in the first technique 900 shown in FIG. 9 or the image analysis performed at 1010 in the second technique 1000 shown in FIG. 10. For example, the image analysis may be any type of computer vision-based analysis that may identify, classify (e.g., sort, group, etc.), count, estimate a volume of, or a combination thereof the inventory items, such as by performing pixel quantification of the furniture unit using a trained machine learning model.

At 1108, the third technique 1100 may determine, based on the image analysis at 1106, a status of the furniture unit. The status of the container may be, for example, a fill status. The fill status may be expressed as a category (e.g., full, partially full, or empty) or as a percentage estimate of volume occupied by inventory items. The status of the furniture unit may be determined in a similar manner to the determination at 908 of the first technique 900 shown in FIG. 9 or the determination at 1012 of the second technique 1000 shown in FIG. 10. In some implementations, the third technique 1100 may also generate an alert when the determined fill status falls below a predefined threshold, such as the alert generated at 910 of the first technique 900 shown in FIG. 9 or the alert generated at 1014 of the second technique 1000 shown in FIG. 10.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc.

Likewise, the terms “system” or “mechanism” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be any device that can, for example, tangibly contain, store, communicate, or transport a program or data structure for use by or in connection with any processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
detecting, by a retrofit device that is retrofit to a furniture unit, a triggering condition;
responsive to detecting the triggering condition, capturing, by an imaging device of the retrofit device, an image of the furniture unit;
performing, by a processor in communication with the retrofit device, image analysis on the image captured by the imaging device; and
determining, based on the image analysis, a status of the furniture unit.

2. The method of claim 1, wherein performing the image analysis includes detecting an inventory item contained in the furniture unit based on one or more features of the inventory item within the image, wherein the one or more features include at least one of color, shape, size, spatial proximity to known reference features, a barcode, or a label.

3. The method of claim 2, further comprising:
detecting the label of the inventory item within the image; and
classifying the inventory item based on the label.

4. The method of claim 1, further comprising:
determining a field of view of an image sensor of the imaging device;
comparing the field of view to a predefined threshold condition; and
responsive to determining that the field of view corresponds to the predefined threshold condition, articulating the imaging device via the retrofit device to adjust the field of view prior to capturing the image.

5. The method of claim 4, wherein articulating the imaging device via the retrofit device includes one or more of translating the imaging device with respect to the furniture unit or rotating the imaging device with respect to the furniture unit.

6. The method of claim 1, further comprising:
determining a field of view of an image sensor of the imaging device based on the image analysis on the image captured by the imaging device;
comparing the field of view to a predefined threshold condition;
responsive to determining that the field of view corresponds to the predefined threshold condition, articulating the imaging device via the retrofit device to adjust the field of view; and
capturing, by the imaging device, an additional image of the furniture unit, wherein the image analysis is performed on the additional image to determine the status of the furniture unit.

7. The method of claim 1, further comprising:
generating an alert when the status of the furniture unit corresponds to a predefined threshold condition; and
transmitting the status of the furniture unit to an inventory management system for one or more of storage, display, or order initiation.

8. The method of claim 1, wherein determining the status of the furniture unit includes one or more of estimating a number of inventory items contained in the furniture unit or estimating a volume of the furniture unit occupied by inventory items.

9. The method of claim 1, wherein the triggering condition comprises motion detection or vibration detection that is detected by the retrofit device.

10. The method of claim 1, wherein the status of the furniture unit is full, partially full, or empty.

11. A system, comprising:
a retrofit device that is configured for retrofitting to a furniture unit and configured to detect a triggering condition, wherein the retrofit device includes:
an imaging device, wherein responsive to detecting the triggering condition, the imaging device is configured to capture an image of the furniture unit; and
a robotic component that is configured to articulate the imaging device to adjust a field of view of an image sensor of the imaging device; and
a server device in communication with the imaging device, wherein the server device comprises a processor configured to:
perform an image analysis on the image captured by the imaging device; and
determine, based on the image analysis, a status of the furniture unit.

12. The system of claim 11, wherein the image analysis includes detecting an inventory item contained in the furniture unit based on one or more features of the inventory item within the image, wherein the one or more features include at least one of color, shape, size, spatial proximity to known reference features, a barcode, or a label.

13. The system of claim 12, wherein the image analysis further includes:
detecting the label of the inventory item within the image; and
classifying the inventory item based on the label.

14. The system of claim 11, wherein the processor is further configured to:
determine a field of view of the image sensor based on the image analysis on the image; and
compare the field of view to a predefined threshold condition,
wherein responsive to determining that the field of view corresponds to the predefined threshold condition, the robotic component is configured to articulate the imaging device to adjust the field of view.

15. The system of claim 11, wherein the processor is further configured to:
generate, based on the status of the furniture unit, an alert; and
transmit the alert to a user device.

16. The system of claim 11, wherein the robotic component includes an articulating device that is configured to one or more of translate the imaging device with respect to the furniture unit or rotate the imaging device with respect to the furniture unit.

17. The system of claim 11, wherein the processor is further configured to:
estimate a number of inventory items contained in the furniture unit to determine whether the furniture unit is full, partially full, or empty.

18. The system of claim 11, wherein the processor is further configured to:
estimate a volume of the furniture unit occupied by inventory items to determine whether the furniture unit is full, partially full, or empty.

19. The system of claim 11, wherein one or more of the imaging device or the robotic component is configured to detect the triggering condition, and wherein the triggering condition comprises motion detection or vibration detection.

20. A method, comprising:
retrofitting a furniture unit with a retrofit device, wherein the retrofit device includes:
an imaging device; and
a robotic component that is configured to articulate the imaging device;
detecting, by one or more of the imaging device or the robotic component, a triggering condition;
responsive to detecting the triggering condition, capturing, by the imaging device, an image of the furniture unit;
performing, by a processor in communication with the retrofit device, image analysis on the image captured by the imaging device; and
determining, based on the image analysis, a status of the furniture unit, wherein the status of the furniture unit is full, partially full, or empty.
